(19) United States
(12) Patent Application Publication
(10) Pub. No.: US 2026/0064065 A1
(43) Pub. Date: Mar. 5, 2026

(54) IMAGE FORMING SYSTEM

(71) Applicant: CANON KABUSHIKI KAISHA, Tokyo (JP)

(72) Inventors: HAJIME SEKIGUCHI, Chiba (JP); TOSHIFUMI ITABASHI, Ibaraki (JP); ISAO KANNARI, Saitama (JP); KOUYOU TAMURA, Chiba (JP); HIROSHI SAITO, Ibaraki (JP)

(21) Appl. No.: 19/301,015

(22) Filed: Aug. 15, 2025

(30) Foreign Application Priority Data
Sep. 2, 2024 (JP) 2024-150648

(51) Int. Cl. G03G 15/00; G03G 21/16

(52) U.S. Cl. CPC G03G 15/6514; G03G 21/1619; G03G 21/1633; G03G 21/1647; G03G 2221/1654

(57) ABSTRACT

An image forming system includes an image forming apparatus, a first sheet feeding apparatus, a second sheet feeding apparatus disposed above the first sheet feeding apparatus and including a tray and a sheet feeding unit, and a sheet supporting apparatus. The sheet supporting apparatus includes a mounting portion configured to be mounted to a mounted portion disposed in the second sheet feeding apparatus, a sheet supporting portion configured to support an upstream side in a sheet conveyance direction of the sheet supported on the tray in a state in which the mounting portion is mounted to the mounted portion, and a first support leg configured to support the sheet supporting portion by coming into contact with a floor surface, on which the image forming apparatus is supported, in the state in which the mounting portion is mounted to the mounted portion.

### BACKGROUND

### Field of the Technology

This disclosure relates to an image forming system including a sheet supporting apparatus that supports a sheet by being mounted to a manual sheet feed unit.

### Description of the Related Art

In recent years, image forming apparatuses are increasingly required to perform image formation on sheets of various sizes. For example, A3-size sheets can be set into some of cassettes arranged inside the image forming apparatuses, while, sometimes, long sheets up to 30 inches (762 millimeters (mm)) in length can be set into sheet feeding apparatuses, such as large capacity decks, that are mounted externally to the image forming apparatuses. Then, for example, there are cases where, for applications such as promotional banners and foldable brochures, image formation is required on sheets with a length of equal to or more than 30 inches, which are further longer than the sheets that can be set into the large capacity decks.

The sheets, for example, with a length of equal to or more than 30 inches, as described above, are set onto so-called manual sheet feed trays for image formation; however, such long sheets often exceed the manual sheet feed trays in length, and trailing edges of the sheets protrude from the trays. When the trailing edges of the sheets protrude from sheet supporting surfaces of the manual feed trays or the like, the trailing edges of the sheets may sag, and cause a risk that the sheets become creased or the sheets may be scratched at corners due to rubbing; therefore, supporting the entire sheet is required.

Accordingly, a configuration is proposed in which the length of a manual sheet feed tray is extended by mounting an extension member (refer to an elongated document storage portion (84) and a holder (91) in Japanese Patent Laid-Open No. 2003-63663). In addition, a configuration is also proposed in which a second holding portion (76) is disposed above a manual sheet feed tray (first holding portion (71)) to provide distributed support for a long sheet (refer to Japanese Patent Laid-Open No. 2007-31093). Further, a configuration is also proposed in which, in a side paper deck portion (100), a manually fed sheet supporting portion (102) is disposed on top of a sheet storage feed portion (101), and supports the sheet, which is set onto a manual sheet feed tray (30e), in conjunction with the manual sheet feed tray (refer to Japanese Patent Laid-Open No. 2008-137742).

### SUMMARY

According to one features of the present disclosure, an image forming system includes an image forming apparatus including an image forming unit configured to form an image on a sheet, a first sheet feeding apparatus detachably disposed on a side surface of the image forming apparatus, and configured to feed the sheet to the image forming unit, a second sheet feeding apparatus disposed on the side surface of the image forming apparatus at a position above the first sheet feeding apparatus, and including a tray configured to support the sheet and a sheet feeding unit configured to feed the sheet supported on the tray to the image forming unit, and a sheet supporting apparatus configured to be mounted to the second sheet feeding apparatus and support the sheet together with the tray. The sheet supporting apparatus includes a mounting portion configured to be mounted to a mounted portion disposed in the second sheet feeding apparatus, a sheet supporting portion configured to support an upstream side in a sheet conveyance direction of the sheet supported on the tray in a state in which the mounting portion is mounted to the mounted portion, and a first support leg configured to support the sheet supporting portion by coming into contact with a floor surface, on which the image forming apparatus is supported, in the state in which the mounting portion is mounted to the mounted portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system provided with a sheet placement platform according to a first embodiment.

FIG. 2 is a perspective view illustrating the image forming system provided with the sheet placement platform according to the first embodiment.

FIG. 3A is a perspective view illustrating a state immediately before the sheet placement platform is mounted to a manual sheet feed unit.

FIG. 3B is a perspective view illustrating a mounting portion of the sheet placement platform.

FIG. 3C is a perspective view illustrating a mounted portion of the manual sheet feed unit.

FIG. 4 is a schematic diagram illustrating a state in which a large capacity deck is separated from an image forming apparatus in the image forming system according to the first embodiment.

FIG. 5 is a schematic diagram illustrating a state in which an access door is opened in the image forming system according to the first embodiment.

FIG. 6 is a schematic diagram illustrating an image forming system provided with a sheet placement platform according to a second embodiment.

FIG. 7 is a schematic diagram illustrating a state in which a large capacity deck is separated from the image forming apparatus in the image forming system according to the second embodiment.

FIG. 8 is a schematic diagram illustrating a state in which the sheet placement platform is separated from the image forming apparatus in the image forming system according to the second embodiment.

FIG. 9 is a schematic diagram illustrating an image forming system provided with a sheet placement platform according to a third embodiment.

### DESCRIPTION OF THE EMBODIMENTS

The configurations described in the above-mentioned Japanese Patent Laid-Open Nos. 2003-63663 and 2007-31093 require the trailing edge of the long sheet to be wound for setup, and, therefore, cannot set up a large number of sheets; in other words, the number of sheets that can be set onto the manual feed tray is limited. In addition, in the configuration described in the above-mentioned Japanese Patent Laid-Open No. 2008-137742, the long sheet cannot be set onto the manual sheet feed tray unless the side paper deck portion is mounted to a printer.

Therefore, this disclosure provides an image forming system provided with a sheet supporting apparatus that enables a manual sheet feed unit to support a greater number of long sheets exceeding the manual feed unit in length in a sheet conveyance direction.

### First Embodiment

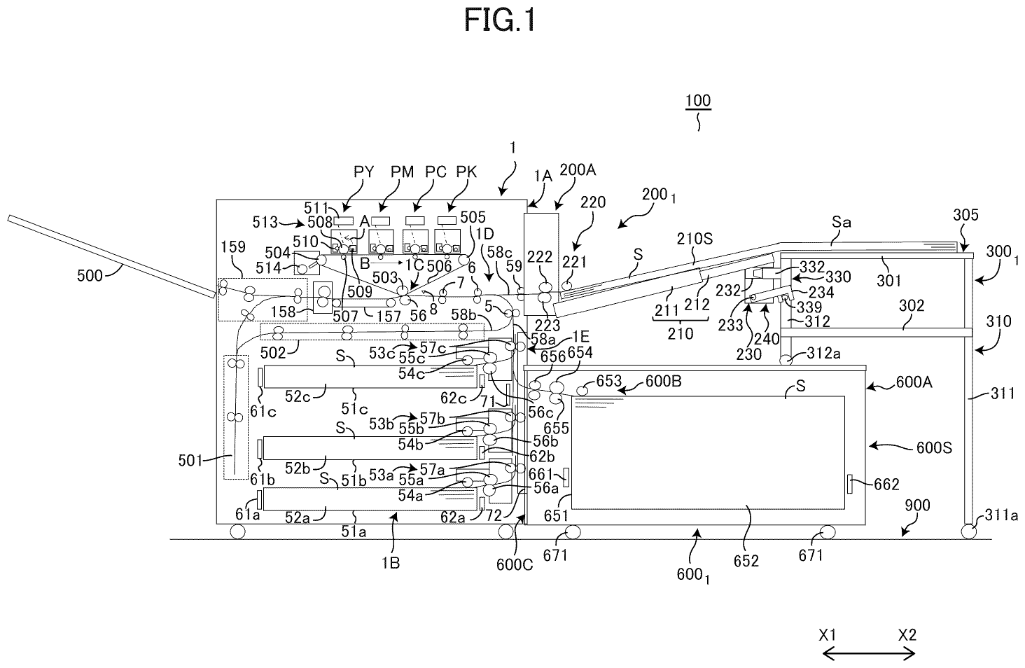

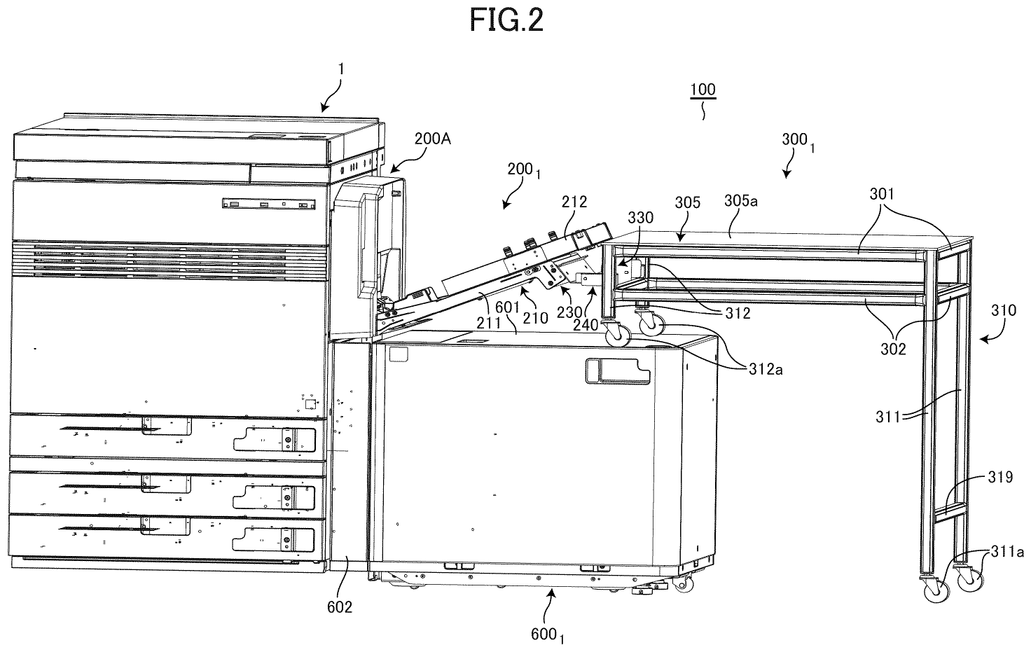

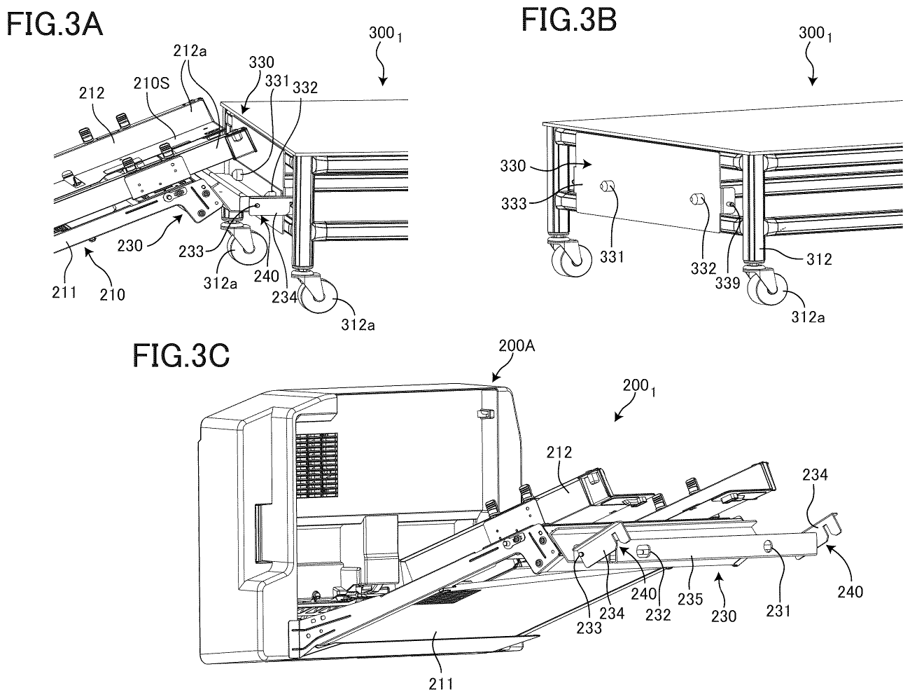

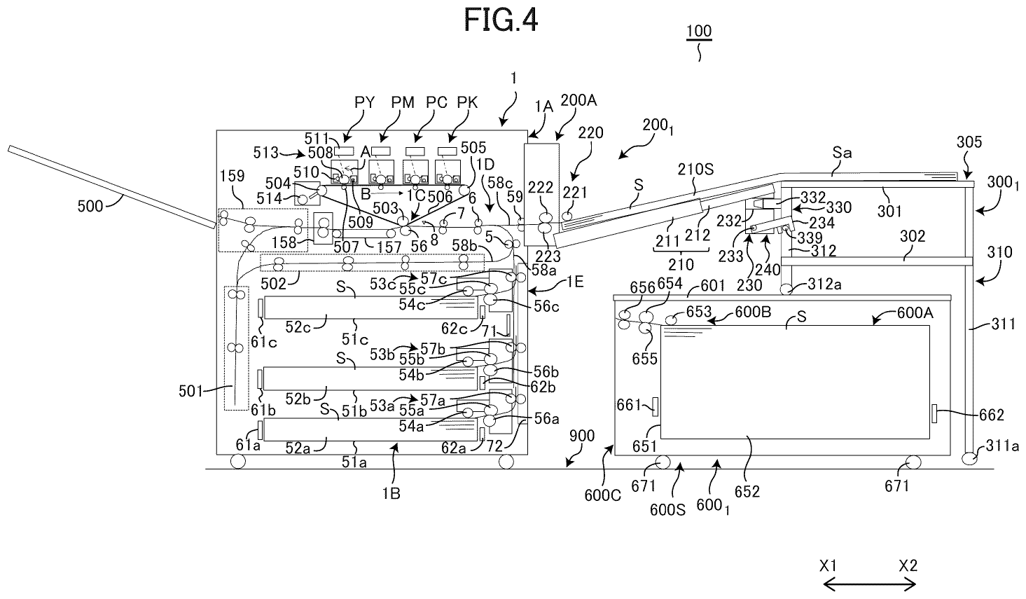

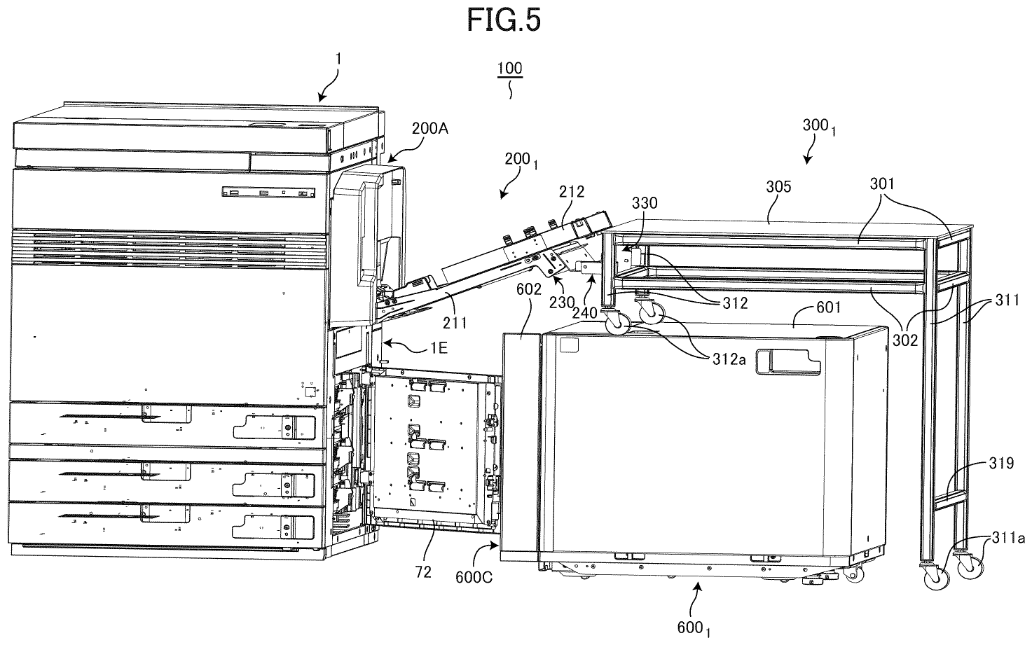

Hereinafter, with reference to FIGS. 1 to 5, a first embodiment will be described. First, a schematic configuration of an image forming system 100, which is provided with a sheet placement platform 300₁, serving as a sheet supporting apparatus according to the first embodiment, a printer 1, serving as an image forming apparatus, and a large capacity deck 600₁, serving as a first sheet feeding apparatus, will be described. FIG. 1 is a schematic diagram illustrating the image forming system provided with the sheet placement platform according to the first embodiment. FIG. 2 is a perspective view illustrating the image forming system provided with the sheet placement platform according to the first embodiment. FIG. 3A is a perspective view illustrating a state immediately before the sheet placement platform is mounted to a manual sheet feed unit, serving as a second sheet feeding apparatus. FIG. 3B is a perspective view illustrating a mounting portion of the sheet placement platform. FIG. 3C is a perspective view illustrating a mounted portion of the manual sheet feed unit. FIG. 4 is a schematic diagram illustrating a state in which the large capacity deck is separated from the image forming apparatus in the image forming system according to the first embodiment. FIG. 5 is a schematic diagram illustrating a state in which an access door is opened in the image forming system according to the first embodiment. To be noted, in the printer 1, as a sheet used as a recording medium, various sheets including paper such as plain paper, an envelope, and glossy paper, a plastic film for overhead projectors, and cloth can be used.

### Schematic Configuration of Printer

First, using FIG. 1, the printer 1 provided in the image forming system 100 will be described. To be noted, an overall operation of the printer 1 is controlled by a control unit, not shown, based on image information input from an external personal computer (PC) or image information read from a document.

As illustrated in FIG. 1, the printer 1 includes an apparatus body 1A, and, in the apparatus body 1A, an image forming engine 513, serving as an image forming unit, that forms an image on a sheet S fed from one of three sheet feed cassettes 51a, 51b, and 51c storing the sheet S is housed. The image forming engine 513 includes four image forming process units PY, PM, PC, and PK, respectively forming toner images of yellow, magenta, cyan, and black, and an intermediate transfer belt 506, serving as an image bearing member. The image forming engine 513 forms the image on the sheet S using a tandem type intermediate transfer method. Each of the image forming process units PY to PK is an electrophotographic unit including a photosensitive drum 508, serving as a photosensitive member.

The image forming process units PY to PK are standardized in configuration except for difference in the color of toner used for development. Here, using the image forming process unit PY of yellow as an example, a configuration of the image forming engine 513 and an image forming process of the toner image will be described. The image forming process unit PY includes an exposing unit 511, a developing unit 510, and a drum cleaner 509, besides the photosensitive drum 508. The photosensitive drum 508 is the drum-shaped photosensitive member with a photosensitive layer on its outer circumference, and rotates in a direction (arrow A direction in FIG. 1) aligned with a rotational direction of the intermediate transfer belt 506 (arrow B direction in FIG. 1). A surface of the photosensitive drum 508 is charged by receiving the supply of electrical charge from a charging device such as a charge roller, not shown. The exposing unit 511 emits laser light modulated according to the image information, scans the photosensitive drum 508, and writes an electrostatic latent image on the surface of the photosensitive drum 508. The developing unit 510 stores developer including the toner, and supplies the toner to the photosensitive drum 508 to visualize the electrostatic latent image as the toner image. The toner image formed on the photosensitive drum 508 is primarily transferred onto the intermediate transfer belt 506 at a primary transfer portion, which is a nip portion between a primary transfer roller 507 and the intermediate transfer belt 506. Residual toner remained on the photosensitive drum 508 after the transfer is collected by the drum cleaner 509.

The intermediate transfer belt 506 is wound around a drive roller 504, a driven roller 505, a secondary transfer inner roller 503, and the primary transfer rollers 507, and is rotatably driven by the drive roller 504 in a clockwise direction (arrow B direction) in FIG. 1. The image forming process described above is performed in parallel in each of the image forming process units PY to PK, and the toner image of a full color is formed on the intermediate transfer belt 506 by overlaying the toner images of four colors through multiple transfer. This toner image is conveyed to a secondary transfer portion 1C while being borne on the intermediate transfer belt 506. The secondary transfer portion 1C is formed as a nip portion between a secondary transfer roller 56, serving as a transfer roller, and the secondary transfer inner roller 503. A bias voltage of charge polarity opposite to that of the toner is being applied to the secondary transfer roller 56; thereby, the toner image is secondarily transferred onto the sheet S. Residual toner remained on the intermediate transfer belt 506 after the transfer is collected by a belt cleaner 514.

The sheet S on which the toner image has been transferred is delivered to a fixing unit 158 by a pre-fixing conveyance unit 157. The fixing unit 158 includes a fixing roller pair, which conveys the sheet by nipping it, and a heat source such as a halogen heater, and applies pressure and heat to the toner image borne on the sheet S. Thereby, toner particles are melted and bonded, and the toner image is fixed on the sheet S.

Sheet Conveyance System within Printer and its Sheet Conveyance

Next, a sheet conveyance process for conveying the sheet will be described. A sheet conveyance system 1D of the printer 1 conveys the sheet S fed from a sheet feed unit 1B, serving as a sheet feeding unit, and discharges the sheet S, on which the image has been formed, to the outside of the apparatus body 1A. The sheet conveyance system 1D includes sheet feed units 53a, 53b, and 53c, a conveyance roller pair 5, a pre-registration roller pair 6, a registration roller pair 7, the pre-fixing conveyance unit 157, a branch conveyance portion 159, a reverse conveyance portion 501, and a duplex conveyance portion 502.

The sheet feed cassettes 51a, 51b, and 51c disposed in the sheet feed unit 1B are mounted in an extractable manner with respect to the apparatus body 1A. In each of the sheet feed cassettes 51a, 51b, and 51c, a plurality of sheets S are stored in a state of being stacked and supported on vertically movable lift trays 52a, 52b, and 52c. In addition, in each of the sheet feed cassettes 51a, 51b, and 51c, positions of leading and trailing edges of the sheet S in the sheet conveyance direction are regulated and determined by leading edge regulation portions 62a, 62b, and 62c and trailing edge regulation portions 61a, 61b, and 61c. To be noted, also in a width direction perpendicular to the sheet conveyance direction, a position of the sheet S is regulated and determined by a regulation portion, not shown. A maximum sheet size that can be stored in these sheet feed cassettes 51a, 51b, and 51c is generally A3-size, which conforms to the standard large format with a width of 297 mm and a length of 420 mm, or sizes up to 13 inches in width by 19 inches in length. A sheet longer than the maximum sheet size that can be stored in these sheet feed cassettes 51a, 51b, and 51c can be referred to as a long sheet.

The sheet S stored in the sheet feed cassettes 51a, 51b, and 51c is fed one sheet at a time by the sheet feed units 53a, 53b, and 53c. In particular, the sheet feed units 53a, 53b, and 53c respectively include pickup rollers 54a, 54b, and 54c which pick up an uppermost sheet. In addition, the sheet feed units 53a, 53b, and 53c respectively include feed rollers 55a, 55b, and 55c and retard rollers 56a, 56b, and 56c, which together form separation roller pairs for separating double-fed sheets into one sheet at a time. Then, the sheet feed units 53a, 53b, and 53c respectively include extraction roller pairs 57a, 57b, and 57c that extract the sheet separated into one sheet at a time at the separation roller pairs and convey the sheet toward the secondary transfer portion 1C. The sheet S conveyed by the extraction roller pair 57a, 57b, or 57c is conveyed through a conveyance path 58a, described in detail below, formed by an access door 72 and a guide member 71, and is delivered to the conveyance roller pair 5, described above.

The sheet S delivered to the conveyance roller pair 5 is conveyed by the pre-registration roller pair 6, and undergoes skew correction and timing adjustment by being conveyed after being abutted against the registration roller pair 7; thereafter, the sheet S is conveyed toward the secondary transfer portion 1C. At this time, based on the detection of the sheet by a sheet detection sensor 8, the registration roller pair 7 delivers the sheet S to the secondary transfer portion 1C in synchronization with the progress of the image forming process by the image forming process units PY to PK. The sheet S, onto which the toner image has been transferred at the secondary transfer portion 1C and on which the image has been fixed by the fixing unit 158, is conveyed to the branch conveyance portion 159 that branches the conveyance path of the sheet S. In a case where the image formation with respect to the sheet S has been completed, the sheet S is discharged to a sheet discharge tray 500, arranged outside the apparatus body 1A, by a sheet discharge roller pair.

On the other hand, in a case of forming the image on a rear surface of the sheet S, the sheet S is delivered to the duplex conveyance portion 502 via the reverse conveyance portion 501. The reverse conveyance portion 501 includes a reverse roller pair capable of forward and reverse rotation, and reverses the sheet by a switchback method that reverses the front and rear surfaces of the sheet S. That is, after retracting the leading edge of the sheet, the reverse conveyance portion 501 switches the front and rear surfaces by reversing the conveyance direction, and delivers the sheet to the duplex conveyance portion 502. The duplex conveyance portion 502 conveys the sheet S again toward the conveyance roller pair 5 via the conveyance path 58b. Then, after the image has been formed on the rear surface, the sheet S is discharged to the sheet discharge tray 500.

### Configuration of Large Capacity Deck and its Sheet Feeding Process

Next, a configuration of the large capacity deck 600₁ and its sheet feeding process will be described. The large capacity deck 600₁ includes an apparatus body 600A, and, within the apparatus body 600A, is provided with a storage compartment 651 capable of storing a plurality of sheets (greater number of sheets than the sheet feed cassettes), and a sheet feed unit 600B that feeds the sheet from the storage compartment 651. The storage compartment 651 is mounted in an extractable manner with respect to the apparatus body 600A. The plurality of sheets S are stored in the storage compartment 651 in a state of being stacked and supported on a vertically movable lift tray 652. In addition, in the storage compartment 651, positions of the leading and trailing edges of the sheet S in the sheet conveyance direction are regulated and determined by a leading edge regulation portion 661 and a trailing edge regulation portion 662. To be noted, also a position in the width direction of the sheet S is regulated and determined by a regulation portion, not shown. A maximum sheet size that can be stored in the storage compartment 651 is generally equal to or less than 30 inches (762 mm) in length; in other words, the storage compartment is compatible with standard long sheets.

The sheet S stored in the storage compartment 651 is fed one sheet at a time by the sheet feed unit 600B. In particular, the sheet feed unit 600B includes a pickup roller 653 for picking up an uppermost sheet, and a feed roller 654 and a retard roller 655 that together form a separation roller pair for separating double-fed sheets into one sheet at a time. In addition, the sheet feed unit 600B includes an extraction roller pair 656 which extracts and conveys the sheet separated into one sheet at a time by the separation roller pair. The sheet S conveyed by the extraction roller pair 656 is conveyed to the conveyance path 58a described above, and delivered to the conveyance roller pair 5 described above. To be noted, since subsequent image forming operations are the same as those performed in a case of feeding the sheet from each of the sheet feed cassettes 51a, 51b, and 51c described above, their description will be omitted.

### Configuration of Manual Sheet Feed Unit and its Sheet Feeding Process

Next, a manual sheet feed unit 200₁ provided in the printer 1 will be described. To be noted, sizes of sheets that can be printed by being set onto the manual sheet feed unit 200₁ include those of long sheets (those exceeding 30 inches (762 mm) in length) which cannot be set into the sheet feed cassettes 51a, 51b, and 51c or the storage compartment 651 of the large capacity deck 600₁. However, of course, sheets with a size compatible with the sheet feed cassettes 51a, 51b, and 51c or the storage compartment 651 of the large capacity deck 600₁ may be set onto the manual sheet feed unit 200₁. In addition, specialty paper and the like, which are recommended to be fed one sheet at a time, can also be set onto the manual sheet feed unit 200₁.

The manual sheet feed unit 200₁ is disposed on a side surface of the printer 1 at a position above the large capacity deck 600₁, and, as illustrated in FIGS. 1 and 2, roughly includes a manual sheet feed tray portion 210, a sheet feed unit 220, a storage portion 200A, and a mounted portion 230, described in detail below. In a case of pivoting around a pivot fulcrum, not shown, as a center to close the manual sheet feed tray portion 210 with respect to the apparatus body 1A of the printer 1, the storage portion 200A houses the manual sheet feed tray portion 210 inside. The storage portion 200A is provided with a lock mechanism, not shown, which engages with the closed manual sheet feed tray portion 210 to lock the manual sheet feed tray portion 210 at a closed position. By releasing this lock mechanism, the manual sheet feed tray portion 210 can pivot around the pivot fulcrum as a center, and can be opened from the storage portion 200A so as to be positioned above the large capacity deck 600₁. Then, it becomes possible to set the sheet S onto a sheet supporting surface 210S of the manual sheet feed tray portion 210, which is in such an opened state.

The manual sheet feed tray portion 210 includes a tray body 211 and an extension tray 212. These tray body 211 and extension tray 212 are each configured as a tray that supports the sheet. The extension tray 212 is arranged on a side of the sheet supporting surface 210S of the tray body 211 (i.e., upper side), and extends the sheet supporting surface 210S by sliding from the tray body 211 in a planar direction of the sheet supporting surface 210S. In addition, when the manual sheet feed tray portion 210 is closed and stored in the storage portion 200A, or when setting a short sheet, the extension tray 212 is moved to overlap the tray body 211. That is, the manual sheet feed tray portion 210 is shortened in the sheet conveyance direction by overlapping the extension tray 212 on the tray body 211. Sheets with a length of, for example, up to 19 inches (483 mm) can be set onto this shortened manual sheet feed tray portion 210. In addition, in a case where the manual sheet feed tray portion 210 is extended by sliding the extension tray 212 with respect to the tray body 211, sheets up to a maximum length of, for example, 30 inches (762 mm) can be set.

In addition, as illustrated in FIG. 3A, the extension tray 212 includes side regulation plates 212a for regulating the width direction perpendicular to the sheet conveyance direction of the sheet that is set onto the sheet supporting surface 210S. These side regulation plates 212a move synchronously via an interlocking mechanism, not shown, in the width direction with respect to a sheet conveyance center line as a center, and regulate positions of the sheet in the width direction by coming into contact with edge portions in the width direction of the sheet. To be noted, at a distal end portion on a side opposite to the pivot fulcrum of the tray body 211, the mounted portion 230, to which a mounting portion 330 of a sheet placement platform 300₁, described in detail below, can be mounted, is arranged.

The sheet S set (manually fed) onto the sheet supporting surface 210S is fed one sheet at a time by the sheet feed unit 220. In particular, the sheet feed unit 220 includes a pickup roller 221 for picking up an uppermost sheet, and a feed roller 222 and a retard roller 223 that together form a separation roller pair for separating double-fed sheets into one sheet at a time. In addition, the sheet feed unit 220 includes an extraction roller pair 59, which extracts and conveys the sheet separated into one sheet at a time by the separation roller pair. The sheet S conveyed by the extraction roller pair 59 is conveyed to a conveyance path 58c, and delivered to the pre-registration roller pair 6. To be noted, since subsequent image forming operations are the same as those performed in a case of feeding the sheet from each of the sheet feed cassettes 51a, 51b, and 51c or the large capacity deck 600₁ described above, their description will be omitted.

To be noted, while, in this embodiment, the manual sheet feed portion 210 includes the tray body 211 and the extension tray 212, it is not limited to this, and the manual sheet feed portion 210 may be configure with a single tray.

### Configuration of Sheet Placement Platform

Next, a configuration of the sheet placement platform 300₁ according to the first embodiment will be described. As illustrated in FIGS. 1 and 2, the sheet placement platform 300₁ is roughly provided with a supporting plate portion 305, serving as a sheet supporting portion, including an upper surface 305a, serving as a sheet supporting surface, and a frame portion 310 that supports that supporting plate portion 305. In addition, the sheet placement platform 300₁ is provided with the mounting portion 330 that can be mounted to the mounted portion 230 of the manual sheet feed unit 200₁. To be noted, details of the mounting portion 330 will be described below.

The frame portion 310 includes a first upper frame 301, a second upper frame 302, two long legs 311, serving as first support legs, and two short legs 312, serving as second support legs. The first upper frame 301 is secured by being connected to at least one of upper ends of the two long legs 311 and the two short legs 312, is arranged in a rectangular configuration when viewed from above, and the supporting plate portion 305 is disposed on top of the first upper frame 301. The second upper frame 302 is secured by being connected to at least one of the two long legs 311 and the two short legs 312 at positions slightly below the first upper frame 301, is similarly arranged in a rectangular configuration when viewed from above, and serves to reinforce the entire frame portion 310. To be noted, in the frame portion 310, a reinforcement frame 319 is arranged so as to connect lower portions of the two long legs 311. To be noted, the supporting plate portion 305 is configured with a flat plane, and its upper surface 305a is formed as a planar surface extending in a horizontal direction.

In addition, at an upstream end portion in the sheet conveyance direction of the supporting portion 305, in a state in which the mounting portion 330, described below, is mounted to the mounted portion 230, the long legs 311 support the supporting plate portion 305 by coming into contact with a floor surface 900 that supports the printer 1. In addition, in the horizontal direction, the long legs 311 are arranged on an opposite side of the printer 1 with respect to an installation space 600S of the large capacity deck 600₁. Further, as described in detail below, in the state in which the mounting portion 330 is mounted to the mounted portion 230, the long legs 311 are arranged at positions at which, in a case where the large capacity deck 600₁ is separated from a connected portion 1E so as to allow the access door 72 to be opened, the long legs 311 do not interfere with the large capacity deck 600₁. That is, when the large capacity deck 600₁ slides to a separated position separated from the connected portion 1E in the state in which the mounting portion 330 is mounted to the mounted portion 230, the long legs 311 are arranged at positions that do not come into contact with the large capacity deck 600₁. In addition, the long legs 311 each include a caster 311a, serving as a first rotary member, at their lower portions. The casters 311a can roll by coming into contact with the floor surface 900 on which the printer 1 is placed; in other words, the sheet placement platform 300₁ can move in an X1-X2 direction along the horizontal direction as the casters 311a roll. To be noted, while, in this embodiment, the term “rotary member” is described using a caster as an example, it is not limited to this, and the term “rotary member” may also include, for example, a roller, a wheel, a belt, or the like; in other words, any member that can rotate and roll at its contact point or ground contact interface is acceptable.

In addition, the short legs 312 each include a caster 312a, serving as a contact portion or a second rotary member, at their lower portions. The caster 312a can come into contact with and roll on an upper surface 601 of the large capacity deck 600₁; in other words, the sheet placement platform 300₁ can relatively move with respect to the large capacity deck 600₁ in the X1-X2 direction along the horizontal direction as the casters 312a roll. Thereby, in a case in which the mounting portion 330 and the mounted portion 230, described below, are in a non-mounted state, the sheet placement platform 300₁ can move independently with respect to the large capacity deck 600₁ and the printer 1 in the horizontal direction. In addition, in the case where the mounting portion 330 and the mounted portion 230, described below, are in the mounted state, the sheet placement platform 300₁ allows the large capacity deck 600₁ to relatively move independently with respect to the printer 1 and the sheet placement platform 300₁ in the horizontal direction.

### Configurations of Mounted Portion of Manual Sheet Feed Unit and Mounting Portion of Sheet Placement Platform

Next, a configuration of the mounted portion 230 of the manual sheet feed unit 200₁ and a configuration of the mounting portion 330 of the sheet placement platform 300₁ will be described. As illustrated in FIG. 3C, the mounted portion 230 of the manual sheet feed unit 200₁ is configure such that the mounting of the mounting portion 330 of the sheet placement platform 300₁, described in detail below, is enabled, and is disposed at the upstream distal end in the sheet conveyance direction of the tray body 211 of the manual sheet feed unit 200₁. The mounted portion 230 includes a base 235, which is a flat plate formed with a round hole 231, serving as a first hole, and an elongated hole 232, serving as a second hole, and a lock mechanism 240 provided in the base 235.

The round hole 231 formed in the base 235 is formed in a perfect circle when viewed from a direction perpendicular to a surface of the base 235. In addition, when viewed from the direction perpendicular to the surface, the elongated hole 232 is formed with a vertical width (diameter) equal to that of the round hole 231, and with a horizontal width greater than the vertical width; thereby, the elongated hole 232 is formed in a so-called slotted hole shape. The lock mechanism 240 includes a pivot shaft 233 pivotably supported by the base 235 described above, two hook levers 234 fixedly supported at both ends of the pivot shaft 233, and two hook shafts 339 (refer to FIG. 3B) disposed within the mounting portion 330, described below.

On the other hand, as illustrated in FIG. 3B, the mounting portion 330 of the sheet placement platform 300₁ includes a base 333, a first pin 331 and a second pin 332 fixedly supported by the base 333, and the two hook shafts 339 described above.

In a case where the sheet placement platform 300₁ is mounted to the manual sheet feed unit 200₁ of the printer 1 by moving the sheet placement platform 300₁ in the X1 direction (refer to FIG. 1) along the horizontal direction, the mounting portion 330 of the sheet placement platform 300₁ is mounted to the mounted portion 230 of the manual sheet feed unit 200₁. At this time, as illustrated in FIGS. 3A, 3B, and 3C, the first pin 331 is inserted into and engaged with the round hole 231, and the second pin 332 is inserted into and engaged with the elongated hole 232; thereby, the mounting portion 330 is positioned with respect to the mounted portion 230. To be noted, since the second pin 332 and the elongated hole 232 engage only in the vertical direction, the insertion of the two pins and holes is facilitated, and it is possible to ensure precise vertical alignment between the sheet supporting surface 210S of the manual sheet feed unit 200₁ and the upper surface 305a of the supporting plate portion 305.

Then, in a state in which the first pin 331 is engaged with the round hole 231 and the second pin 332 is engaged with the elongated hole 232, as described above, the hook levers 234 of the lock mechanism 240 are pivoted in a clockwise direction in FIG. 3A, and are engaged with the hook shafts 339. Thereby, the movement of the mounted portion 230 and the mounting portion 330 in a separation direction (the X2 direction in the horizontal direction, opposite to an insertion direction of the first and second pins 331 and 332) is locked; in other words, it is possible to lock the mounted state in which the sheet placement platform 300₁ is mounted to the printer 1. A mounting interface between the mounted portion 230 and the mounting portion 330, which are configured as described above, firmly maintains the mounted state, especially in the vertical direction, due to the engagement of the first and second pins 331 and 332 with the round and elongated holes 231 and 232. Therefore, even when stacking approximately 100 to 250 sheets, which is specified loading capacity of the manual sheet feed unit 200₁, it is possible to securely support the sheet weight in view of mechanical rigidity.

In addition, the mounted portion 230 of the manual sheet feed unit 200₁ is arranged directly below the extension tray 212, in other words, is arranged at a position adjacent to the sheet supporting surface 210S. Further, the mounting portion 330 of the sheet placement platform 300₁ is arranged directly below the supporting plate portion 305; in other words, the mounting portion 330 is arranged at a position adjacent to the upper surface 305a of the supporting plate portion 305. Since, as described above, a structure positioned by the mounted portion 230 and the mounting portion 330 is located adjacent to the sheet supporting surface 210S of the manual sheet feed tray portion 210 and the upper surface 305a of the supporting plate portion 305, the impact of component tolerance variations can be reduced. Thereby, a step between the sheet supporting surface 210S and the upper surface 305a can be reduced, and a posture of the sheet S during a feeding operation of the sheet S can be stabilized.

On the other hand, by pivoting the hook levers 234 of the lock mechanisms 240 in a counterclockwise direction in FIG. 3A, engagement with the hook shafts 339 can be released. Thereby, the mounted portion 230 and the mounting portion 330 are brought into the non-mounted state, and are enabled to move in the separation direction; in other words, movement for separating the sheet placement platform 300₁ from the printer 1 is enabled.

### Support of Long Sheet by Sheet Placement Platform

As illustrated in FIG. 1, in the case where the mounting portion 330 and the mounted portion 230 are in the mounted state, the supporting plate portion 305 of the sheet placement platform 300₁ described above becomes such that the sheet supporting surface 210S of the manual sheet feed unit 200₁ is continuous with the upper surface 305a. In other words, in addition to the extension tray 212 described above, the supporting plate portion 305 possesses a function of an extension tray that further extends a supporting surface for stacking the sheet S. That is, when setting a long sheet S with a length equal to or larger than 30 inches, which is longer than the sheet supporting surface 210S of the manual sheet feed unit 200₁ in the sheet conveyance direction, onto the manual sheet feed unit 200₁, the sheet placement platform 300₁ supports a trailing edge portion Sa, which is on the upstream side in the sheet conveyance direction of the sheet S. Then, the sheet placement platform 300₁ of this embodiment includes the long legs 311 that come into contact with the floor surface 900 and support the supporting plate portion 305, as described above. Therefore, even when stacking approximately 100 to 250 long sheets S, which exceed 30 inches in length, which is the specified loading capacity of the manual sheet feed unit 200₁, the manual sheet feed unit 200₁ and the sheet placement platform 300₁ can securely support the sheet weight in view of mechanical rigidity.

That is, for example, with the configurations disclosed in Japanese Patent Laid-Open Nos. 2003-63663 and 2007-31093, it is necessary to wind a trailing edge portion of the sheet set onto the manual sheet feed unit 200₁, and, therefore, it is not possible to stack a large number of sheets, for example, 100 to 250 sheets. In addition, for example, in cases of configurations in which wire trays or the like are connected to manual sheet feed trays, such configurations lack sufficient structural rigidity, and may produce press marks on sheets due to the weight; therefore, it is not desirable to stack a large number of sheets, for example, 100 to 250 sheets. Further, with the configuration disclosed in Japanese Patent Laid-Open No. 2008-137742, a long sheet exceeding a manual sheet feed tray in length cannot be set unless a large capacity deck (side paper deck portion) is mounted to a printer. Besides that, with the configuration disclosed in Japanese Patent Laid-Open No. 2008-137742, it is not possible to set a sheet that exceeds the length of the large capacity deck in the sheet conveyance direction (for example, a sheet exceeding 30 inches in length).

With respect to these issues, the sheet placement platform 300₁ of this embodiment can support the long sheet that exceeds the length of the large capacity deck 600₁, i.e., 30 inches. Then, it becomes possible to support a greater number of long sheets, such as, for example, 100 to 250 sheets, on the manual sheet feed unit 200₁. Therefore, it is possible to reduce the occurrence of damage to the manual sheet feed unit 200₁, the occurrence of the dislodgment of a set long sheet, the occurrence of feeding errors, and the like. In addition, since a large number of sheets, such as, for example, 100 to 250 sheets, can be set onto the manual sheet feed unit 200₁ simultaneously, it is possible to improve the productivity of printed matter.

Connected State and Separated State of Large Capacity Deck with Respect to Printer

Next, a connected state in which the large capacity deck 600₁ is connected with respect to the printer 1, and a separated state (maintenance position) in which the large capacity deck 600₁ is separated from the printer 1 will be described.

As illustrated in FIG. 1, a plurality of casters 671 are disposed beneath the apparatus body 600A of the large capacity Deck 600₁, and the large capacity deck 600₁ is movable in the X1-X2 direction, which is the horizontal direction, by these casters 671. The printer 1 includes the connected portion 1E to which the large capacity deck 600₁ can be connected in a state in which the access door 72, serving as an opening/closing portion disposed in the apparatus body 1A, is closed. When viewed in the arrow X1 direction along the horizontal direction, this access door 72 is arranged at a position at least overlapping the connected portion 1E; in other words, it is configured such that, unless the access door 72 is closed, the connected portion 1E is not formed, and, thus, the large capacity deck 600₁ cannot be connected. Conversely, it is configured such that, unless the large capacity deck 600₁ is not separated from the connected portion 1E, the access door 72 cannot be opened. Then, the access door 72 is arranged to face the guide member 71 described above in the closed state, and forms part of the conveyance path 58a described above. Therefore, in a case where a sheet jam (paper feed error) or the like occurs in this conveyance path 58a, it becomes possible to remove the jammed sheet by opening the access door 72.

On the other hand, the large capacity deck 600₁ includes a connection portion 600C that can be connected to the connected portion 1E. A lock mechanism, illustration omitted, is disposed in the connection portion 600C of the large capacity deck 600₁ and the connected portion 1E of the printer 1, and it is possible to maintain a connected state between the printer 1 and the large capacity deck 600₁ by locking that lock mechanism. When the large capacity deck 600₁ is connected to the printer 1, it becomes possible to feed the sheet S stored in the large capacity deck 600₁ to the printer 1 as described above. To be noted, as illustrated in FIGS. 2 and 5, in the large capacity deck 600₁, a cover 602 is disposed to cover a front side of its connecting portion in a case of being connected to the printer 1.

Then, by performing an operation to disengage the lock mechanism, not shown, the large capacity deck 600₁ is enabled to move with respect to the printer 1 in the arrow X2 direction along the horizontal direction. Therefore, as illustrated in FIGS. 4 and 5, it is possible to bring the large capacity deck 600₁ into the separated state of being separated with respect to the printer 1. Thereby, as illustrated in FIG. 5, it becomes possible to open the access door 72 of the printer 1 described above to the maintenance position, possible to remove the sheet in the conveyance path 58a, and possible to perform maintenance operations within the printer 1.

In this embodiment, the upper surface 601 of the apparatus body 600A of the large capacity deck 600₁ described above is formed as a flat plane, and the casters 312a of the short legs 312 of the sheet placement platform 300₁ can come into contact with and roll on the upper surface 601. Thereby, the large capacity deck 600₁ and the sheet placement platform 300₁ can relatively move with respect to the horizontal direction. In addition, as described above, the long legs 311 of the sheet placement platform 300₁ are arranged on the side opposite to the printer 1 with respect to the installation space 600S of the large capacity deck 600₁; in other words, the long legs 311 are arranged outside the installation space 600S. Therefore, it is possible to open the access door 72 by separating the large capacity deck 600₁ from the printer 1 while maintaining the mounted state of the mounted portion 230 of the manual sheet feed unit 200₁ and the mounting portion 330 of the sheet placement platform 300₁, in other words, without moving the sheet placement platform 300₁. In summary, in a case where the sheet jam (paper feed error) or the like occurs in the conveyance path 58a of the printer 1, it is possible to perform jam processing while maintaining the long sheet S set onto the manual sheet feed unit 200₁ and the sheet placement platform 300₁. In other words, it is possible to eliminate the need for an operation to move the long sheet S so as to temporarily remove the long sheet S from the manual sheet feed unit 200₁ and the sheet placement platform 300₁ for the jam processing.

To be noted, for example, in a case of performing service maintenance operations of the printer 1 or the large capacity deck 600₁, only by operating the lock mechanism and by disengaging the locking of the mounted portion 230 and the mounting portion 330, it is possible to easily move the sheet placement platform 300₁. Therefore, it is possible to perform the service maintenance operations of the printer 1 or the large capacity deck 600₁ smoothly.

### Second Embodiment

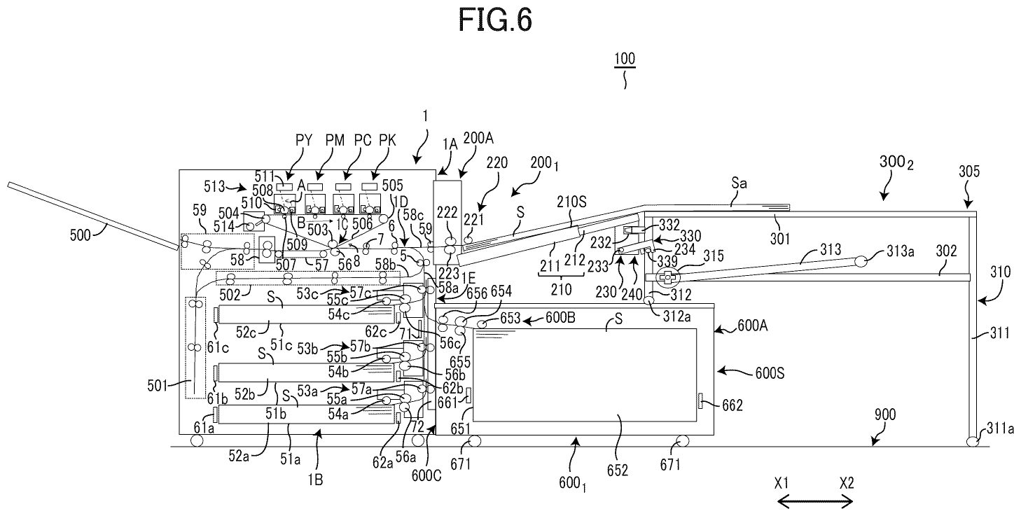

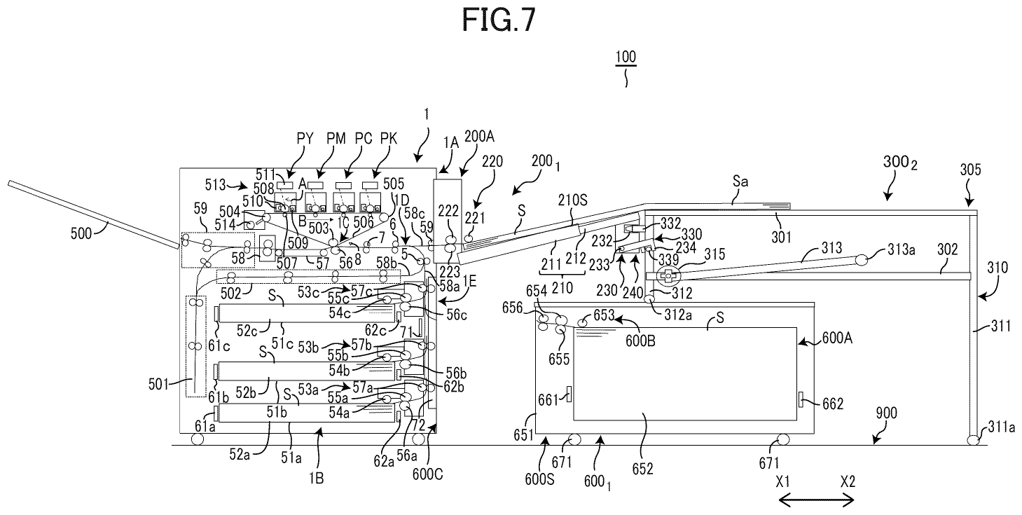

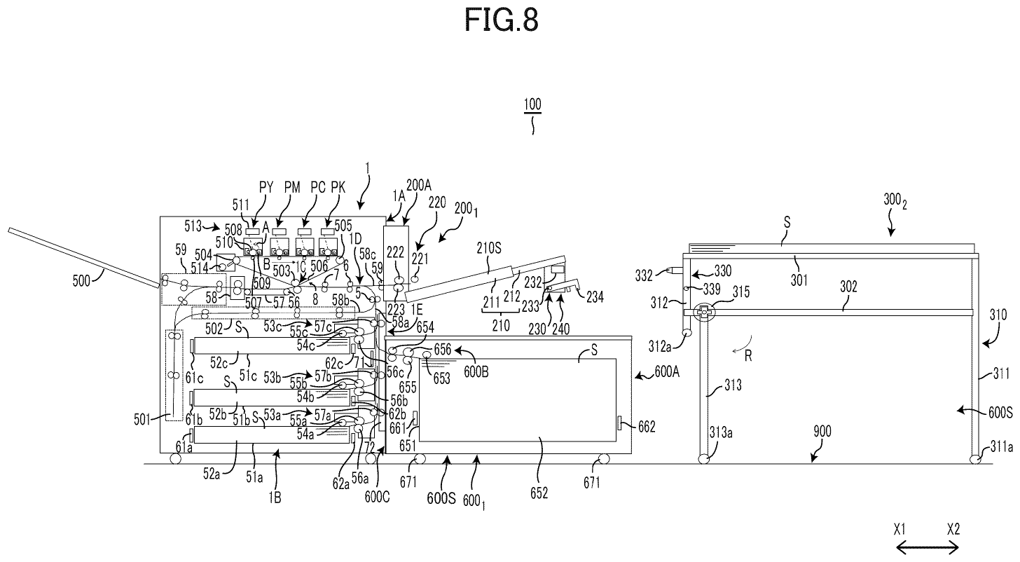

Next, using FIGS. 6 to 8, a second embodiment, in which part of the first embodiment described above is modified, will be described. FIG. 6 is a schematic diagram illustrating an image forming system provided with a sheet placement platform according to the second embodiment. FIG. 7 is a schematic diagram illustrating a state in which the large capacity deck is separated from the image forming apparatus in the image forming system according to the second embodiment. FIG. 8 is a schematic diagram illustrating a state in which the sheet placement platform is separated from the image forming apparatus in the image forming system according to the second embodiment. To be noted, in the description of this second embodiment, the same reference characters are used for elements similar to those described in the abovementioned first embodiment, and their descriptions will be omitted.

As illustrated in FIGS. 6, 7, and 8, in comparison with the sheet placement platform 300₁ (refer to FIG. 1), the sheet placement platform 300₂ according to the second embodiment is formed to be larger with respect to the sheet conveyance direction, and the supporting plate portion 305 is formed with greater length. In addition, the sheet placement platform 300₂ includes a plurality of pivot legs 313, serving as third supporting legs capable of pivoting between a retracted position and a contact position.

In particular, as illustrated in FIG. 8, the supporting plate portion 305 of the sheet placement platform 300₂ is configured with sufficient size to support the entire (full length) of the long sheet S larger than, for example, 30 inches. Therefore, when moving the sheet placement platform 300₂ by disengaging the mounted state of the mounted portion 230 and the mounting portion 330, as illustrated in FIG. 8, the long sheet S can be transferred from a state of being set onto the manual sheet feed unit 200₁ onto the supporting plate portion 305 of the sheet placement platform 300₂.

In addition, through manually operated screws 315, serving as retention mechanisms, the pivot legs 313 are configured to pivot with respect to the second upper frame 302 and to be held (fixed) in position. In addition, the pivot legs 313 include casters 313a, serving as third rotary members that roll in contact with the floor surface 900, at ends of the pivot legs 313 on a side opposite to the manually operated screws 315. That is, as illustrated in FIGS. 6 and 7, by retracting upward from the installation space 600S of the large capacity deck 600₁, the pivot legs 313 can pivot to the retracted position where the height becomes equal to or higher than that of the second upper frame 302, and can be held at the retracted position by tightening the manually operated screws 315. To be noted, at this retracted position, the pivot legs 313 are separated from the floor surface 900, and is in a state of being stored between the first and second upper frames 301 and 302; therefore, this position may also be referred to as a storage position. In addition, as illustrated in FIG. 8, by loosening the manually operated screws 315, the pivot legs 313 can pivot to the contact position where the casters 313a are brought into contact with the floor surface 900, and, by tightening the manually operated screws 315, can be retained at that contact position. As described above, the user can easily change the positions of the pivot legs 313 only by loosening and tightening the manually operated screws 315.

As illustrated in FIG. 6, by being mounted to the manual sheet feed unit 200₁, similar to the first embodiment, the sheet placement platform 300₂ described above enables the manual sheet feed unit 200₁ to support the long sheet that exceeds the large capacity deck 600₁ in length, i.e., longer than 30 inches. In addition, it is possible to enable the manual sheet feed unit 200₁ to support a greater number of long sheets, such as, for example, 100 to 250 sheets. In addition, in a case where the sheet jam (paper feed error) or the like occurs in the conveyance path 58a of the printer 1, as illustrated in FIG. 7, while maintaining the long sheet S set onto the manual sheet feed unit 200₁ and the sheet placement platform 300₂, it is possible to separate the large capacity deck 600₁ from the printer 1. Therefore, it is possible to perform the jam processing, while maintaining the long sheet S set onto the manual sheet feed unit 200₁ and the sheet placement platform 300₂.

Then, as illustrated in FIG. 8, by transferring the sheet S onto the supporting plate portion 305 and by pivoting the pivot legs 313 to the contact position, the sheet placement platform 300₂ according to the second embodiment is enabled to move while stacking the sheet S. Thereby, for example, the sheet placement platform 300₂ can transport the long sheet from a storage location by stacking the long sheet on the sheet placement platform 300₂. Further, by directly mounting the sheet placement platform 300₂ to the manual sheet feed unit 200₁ and by moving the leading edge of the sheet S toward the manual sheet feed unit 200₁, it is possible to easily set the sheet S onto the manual sheet feed unit 200₁. As described above, even the long sheet, for example, exceeding 30 inches in length, can be easily transported, and a transfer operation of the sheet S on the manual sheet feed unit 200₁ is streamlined; therefore, it is possible to enhance operational efficiency.

To be noted, in this second embodiment, the pivot legs 313 are described as examples of third support legs that move to the retracted position and the contact position. However, it is not limited to this, and extendable support legs or detachable support legs may be used. In other words, any type of support legs is acceptable if they are retractable when the large capacity deck is positioned beneath, and are capable of coming into contact with the floor surface when the large capacity deck is not positioned beneath.

In addition, while, in this second embodiment, only the pivot legs 313 move from the contact position to the retracted position, it is not limited to this, and the long legs 311 may also be configured to move to the retracted position such that the long legs 311 pivot, contract, or are detached to fold at positions corresponding to the length of the short legs 312. In a case configured as described above, by retracting both the pivot legs 313 and the long legs 311, it is possible to reduce the vertical dimension of the sheet placement platform 300, and thus possible to reduce a storage space required for the sheet placement platform 300.

To be noted, configurations, functions, and effects pertaining to this second embodiment other than those mentioned above are equivalent to those described in the first embodiment described above, and thus further description will be omitted.

### Third Embodiment

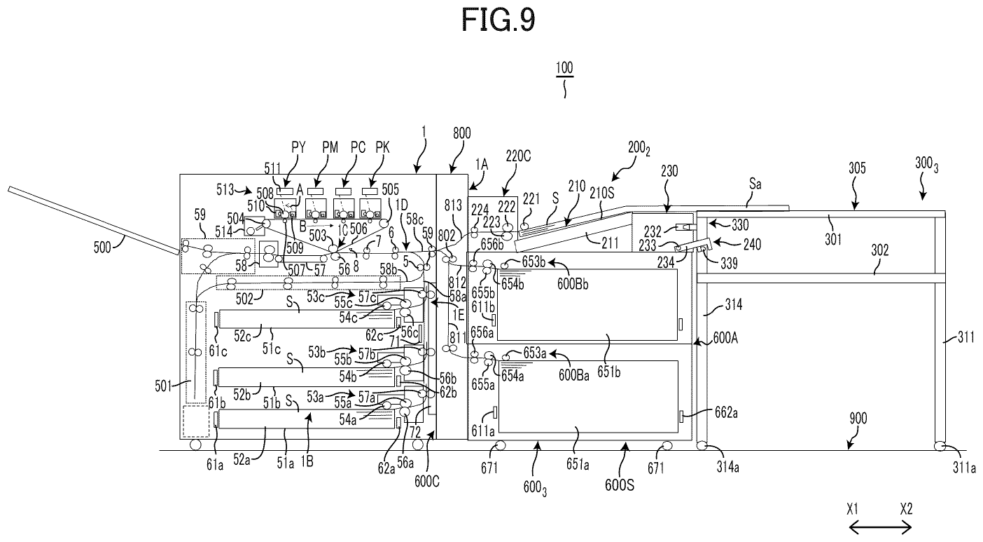

Next, using FIG. 9, a third embodiment, in which part of the first embodiment described above is modified, will be described. FIG. 9 is a schematic diagram illustrating an image forming system provided with a sheet placement platform according to the third embodiment. To be noted, in the description of this third embodiment, the same reference characters are used for elements similar to those described in the abovementioned first embodiment, and their description will be omitted.

As illustrated in FIG. 9, the image forming system 100 according to the third embodiment includes a buffer conveyance apparatus 800 disposed between the printer 1 and a large capacity deck 600₃. In addition, the large capacity deck 600₃ according to the third embodiment includes two storage compartments 651a and 651b, and a manual sheet feed unit 200₂; in other words, the manual sheet feed unit 200₂ is not provided in the printer 1, but in the large capacity deck 600₃. Then, the sheet placement platform 300₃ according to the third embodiment is formed with a larger dimension with respect to the sheet conveyance direction and a more extended supporting plate portion 305 in length compared to the sheet placement platform 300₁ of the first embodiment described above (refer to FIG. 1). In addition, the sheet placement platform 300₃ includes a long leg 314, serving as a fourth support leg, on a side closer to the printer 1 (large capacity deck 600₃) than the long legs 311.

In particular, the large capacity deck 600₃ includes the apparatus body 600A, and, within the apparatus body 600A, is provided with the storage compartments 651a and 651b capable of storing a plurality of sheets, and sheet feed units 600Ba and 600Bb for feeding the sheet stored in the storage compartments 651a and 651b. Each of the storage compartments 651a and 651b is mounted in an extractable manner with respect to the apparatus body 600A. In each of the storage compartments 651a and 651b, the plurality of sheets S are stored in a state of being stacked and supported on vertically movable lift trays 662a and 662b. In addition, in each of the storage compartments 651a and 651b, the positions of the leading and trailing edges in the sheet conveyance direction of the sheet S are regulated and determined by leading edge regulation portions 661a and 661b and trailing edge regulation portions 662a and 662b. To be noted, also in the width direction, the position of the sheet S is regulated and determined by a regulation portion, not shown. A maximum sheet size that can be stored in the storage compartments 651a and 651b is equal to or less than 30 inches (762 mm) in length.

The sheet S stored in each of the storage compartments 651a and 651b is fed one sheet at a time by the sheet feed units 600Ba and 600Bb. In particular, the sheet feed units 600Ba and 600Bb respectively include pickup rollers 653a and 653b for picking up an uppermost sheet. In addition, the sheet feed units 600Ba and 600Bb respectively include feed rollers 654a and 654b and retard rollers 655a and 655b, which together form separation roller pairs for separating double-fed sheets into one sheet at a time. In addition, the sheet feed units 600Ba and 600Bb respectively include extraction roller pairs 656a and 656b which extract and convey the sheet separated into one sheet at a time by the separation roller pairs. Of these, the sheet S conveyed by the extraction roller pair 656a is conveyed to a conveyance path 811 of the buffer conveyance apparatus 800, is conveyed to a conveyance roller pair 802 by a conveyance roller pair 801, and is then delivered to an extraction roller pair 59 of the printer 1 described above. In addition, the sheet S conveyed by the extraction roller pair 656b is conveyed to a conveyance path 812 of the buffer conveyance apparatus 800, and is delivered to the extraction roller pair 59 of the printer 1 by being conveyed by the conveyance roller pair 802. To be noted, since subsequent image forming operations are the same as those performed in a case of feeding the sheet from the manual sheet feed unit 200₁ in the first embodiment, their description will be omitted.

In the large capacity deck 600₃, the manual sheet feed unit 200₂ is disposed on top of the apparatus body 600A. The manual sheet feed unit 200₂ includes the manual sheet feed tray portion 210, the sheet feed unit 220, a sheet feeding portion case 220C, and the mounted portion 230. In the manual sheet feed unit 200₂ according to this third embodiment, the manual sheet feed tray portion 210 is configured only with the tray body 211, and an upper surface of the tray body 211 forms the sheet supporting surface 210S.

The sheet feed unit 220 includes the pickup roller 221 for picking up an uppermost sheet, the feed roller 222 and the retard roller 223, which together form the separation roller pair for separating double-fed sheets into one sheet at a time, and an extraction roller pair 224. In addition, in the sheet feed unit 220, the feed roller 222, the retard roller 223, and the extraction roller pair 224 are housed inside the sheet feeding portion case 220C. The sheet S, which has been picked up by the pickup roller 221 and separated into one sheet at a time by the separation roller pair, is conveyed to a conveyance path 813 of the buffer conveyance apparatus 800 by the extraction roller pair 224. The sheet S conveyed to the conveyance path 813 is conveyed by a conveyance roller pair 802, and is delivered to the extraction roller pair 59 of the printer 1 described above. To be noted, since subsequent image forming operations are the same as those performed in a case of feeding the sheet from the manual sheet feed unit 200₁ in the first embodiment, its description will be omitted. In addition, since the configuration of the mounted portion 230 is the same as that of the first embodiment described above, its description will be omitted.

As illustrated in FIG. 9, similar to the sheet placement platform 300₂ according to the second embodiment (refer to FIGS. 6 to 8), the sheet placement platform 300₃ according to the third embodiment is formed with an extended length. In addition, on a side opposite to the printer 1 with respect to the installation space 600S of the large capacity deck 600 and on a side closer to the installation space 600S than the long legs 311, the sheet placement platform 300₃ is provided with a plurality of long legs 314, each having the same length as the long legs 311.

In particular, similar to the second embodiment, the sheet supporting plate portion 305 of the sheet placement platform 300₃ according to the third embodiment is configured with sufficient size to support the entire (full length) of the long sheet S larger than, for example, 30 inches. Thereby, when moving the sheet placement platform 300₃ by disengaging the mounted state of the mounted portion 230 and the mounting portion 330, the long sheet S can be transferred from a state of being set onto the manual sheet feed unit 200₂ onto the supporting plate portion 305 of the sheet placement platform 300₃.

In addition, in a state in which the mounting portion 330 is mounted to the mounted portion 230 at a downstream end portion in the sheet conveyance direction of the supporting plate portion 305, the long legs 314 come into contact with the floor surface 900, which supports the printer 1, and support the supporting plate portion 305. In addition, the long legs 314 are arranged opposite to the printer 1 in the horizontal direction with respect to the installation space 600S of the large capacity deck 600₃. In addition, each of the long legs 314 includes a caster 314a, serving as a fourth rotary member, at its lower portion, and this caster 314a can roll in contact with the floor surface 900 on which the printer 1 is placed. That is, the sheet placement platform 300₃ can move in the X1-X2 direction along the horizontal direction as the casters 311a of the long legs 311 and the casters 314a of the long legs 314 roll.

To be noted, in this third embodiment, after being connected to the printer 1, the large capacity deck 600₃ is not expected to be moved during standard jam processing and maintenance operations. For example, in a case where the sheet jam occurs inside the buffer conveyance apparatus 800 or within the conveyance path 58a, by opening a door, illustration omitted, of the buffer conveyance apparatus 800, and, if necessary, by opening the access door 72, it is possible to remove the jammed sheet.

Similar to the first embodiment, by being mounted to the manual sheet feed unit 200₂, the sheet placement platform 300₃ described above enables the manual sheet feed unit 200₂ to support the long sheet that exceeds the large capacity deck 600₃ in length, i.e., longer than 30 inches. In addition, it is possible to enable the manual sheet feed unit 200₂ to support a greater number of long sheets, such as, for example, 100 to 250 sheets.

Then, by transferring the sheet S onto the supporting plate portion 305, the sheet placement platform 300₃ according to this third embodiment enables the movement of the sheet S using the long legs 311 and 314 while stacking the sheet S. Thereby, for example, the long sheet can be transported from a storage location by stacking the long sheet on the sheet placement platform 300₃. Further, by directly mounting the sheet placement platform 300₃ to the manual sheet feed unit 200₂ and by moving the leading edge of that sheet S toward the manual sheet feed unit 200₂, it is possible to easily set the sheet S onto the manual sheet feed unit 200₂. As described above, even the long sheet, for example, exceeding 30 inches in length, can be easily transported, and a transfer operation of the sheet S on the manual sheet feed unit 200₂ is streamlined; therefore, it is possible to enhance operational efficiency.

To be noted, configurations, functions, and effects pertaining to this second embodiment other than those mentioned above are equivalent to those described in the first embodiment described above, and thus further description will be omitted.

### POSSIBILITIES OF OTHER EMBODIMENTS

To be noted, in the first to third embodiments described above, the sheet with a length of up to 30 inches (762 mm) can be set into the large capacity deck 600 and onto the manual sheet feed tray portion 210 with the extension tray 212 extended. In other words, by utilizing the sheet placement platform 300, it becomes possible to set the sheet exceeding 30 inches in length. However, the size of the sheet that can be set into or onto each unit is not limited to this. For example, in a case where the sheet up to 900 mm in length can be set into the large capacity deck 600 or onto the manual sheet feed tray portion 210, it is acceptable to use the sheet placement platform 300 to enable the setting of the sheet longer than 900 mm.

In addition, in the first to third embodiments, the first and second pins 331 and 332 are disposed in the sheet placement platform 300, and the round and elongated holes 231 and 232 are disposed in the mounted portion 230 of the manual sheet feed unit 200. However, it is not limited to this, and it is also acceptable to dispose two holes in the mounting portion 330 of the sheet placement platform 300 and provide two pins in the mounted portion 230 of the manual sheet feed unit 200. Further, it is also acceptable to dispose one hole and one pin in the mounting portion 330 of the sheet placement platform 300 and provide one hole and one pin in the mounted portion 230 of the manual sheet feed unit 200. In other words, it is acceptable that the mounted portion 230 includes one of a first pin extending in the mounting direction and a first hole for engaging with the first pin, and one of a second pin extending in the mounting direction and a second hole which fits with the second pin in the vertical direction and is longer than the second pin with respect to the horizontal direction, while the mounting portion 330 includes the other of the first pin and the first hole, and the other of the second pin and the second hole.

In addition, in the first and second embodiments, by disposing the casters 312a, which come into contact with the large capacity deck 600, at the short legs 312, the relative movement of the sheet placement platform 300 and the large capacity deck 600 is enabled. However, it is not limited to this, and, for example, a configuration such as a rail-and-wheel may be employed, or a simple sliding mechanism may be used; in other words, as long as the short leg 312 can come into contact with the large capacity deck 600 and enables the relative movement while bearing the weight, any such configuration is acceptable.

In addition, in the first to third embodiments, by providing the long legs 311 with the casters 311a, the sheet placement platform 300 is enabled to move on the floor surface 900. However, it is not limited to this, and the sheet placement platform 300 may be simply installed on the floor surface 900. Similarly, the pivot legs 313 in the second embodiment and the long legs 314 in the third embodiment may also be configured such that the sheet placement platform 300 is installed on the floor surface 900.

In addition, in the first to third embodiments, the upper surface 305a of the supporting plate portion 305 of the sheet placement platform 300 is formed as a planar surface, and extends in the horizontal direction. However, it is not limited to this, and, for example, the upper surface 305a may be inclined at an angle of about 10 degrees with respect to the horizontal direction, and a certain degree of curvature that allows convenient stacking of, for example, about 100 to 250 sheets is acceptable.

In addition, in the first and second embodiments, the sheet placement platform 300 is provided with the two long legs 311 and the two short legs 312; however, it is not limited to this, and it is acceptable as long as the total number of long legs 311 and short legs 312 is equal to or more than three legs. That is, if there are equal to or more than two short legs 312, there may be one long leg 311, and, if there are equal to or more than two long legs 311, there may also be one short leg 312. In addition, in the second embodiment, the number of pivot legs 313 may be equal to or more than the number of short legs 312.

In addition, similarly, in the third embodiment, the sheet placement platform 300 is provided with the two long legs 311 and the two long legs 314; however, it is not limited to this, and it is acceptable as long as the total number of long legs 311 and long legs 314 is equal to or more than three legs. That is, if there are equal to or more than two long legs 314, there may be one long leg 311, and, if there are equal to or more than two long legs 311, there may also be one long leg 314.

In addition, in the first to third embodiments, the image forming system 100 is provided with the large capacity deck 600. However, it is not limited to this, and even in an image forming system which is in a state in which the sheet placement platform 300 is mounted to the printer 1 and the large capacity deck 600 is not connected to the printer 1, it is still possible to set the long sheet onto the manual sheet feed unit 200.

In addition, the printer 1 and the large capacity deck 600 described in the first to third embodiments are merely examples, and any type may be used. In particular, the printer, serving as the image forming apparatus, may include any type of an image forming unit, including monochrome laser types, inkjet types, or the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-150648, filed Sep. 2, 2024, which is hereby incorporated by reference herein in its entirety.

What is claimed is:

1. An image forming system comprising:
an image forming apparatus including an image forming unit configured to form an image on a sheet;
a first sheet feeding apparatus detachably disposed on a side surface of the image forming apparatus, and configured to feed the sheet to the image forming unit;
a second sheet feeding apparatus disposed on the side surface of the image forming apparatus at a position above the first sheet feeding apparatus, and including a tray configured to support the sheet and a sheet feeding unit configured to feed the sheet supported on the tray to the image forming unit; and
a sheet supporting apparatus configured to be mounted to the second sheet feeding apparatus and support the sheet together with the tray,
wherein the sheet supporting apparatus includes:
a mounting portion configured to be mounted to a mounted portion disposed in the second sheet feeding apparatus;
a sheet supporting portion configured to support an upstream side in a sheet conveyance direction of the sheet supported on the tray in a state in which the mounting portion is mounted to the mounted portion; and
a first support leg configured to support the sheet supporting portion by coming into contact with a floor surface, on which the image forming apparatus is supported, in the state in which the mounting portion is mounted to the mounted portion.

2. The image forming system according to claim 1,
wherein the tray is disposed pivotably with respect to the side surface of the image forming apparatus.

3. The image forming system according to claim 1,
wherein the image forming apparatus includes a connected portion configured to connect the first sheet feeding apparatus, and
wherein the first support leg is located at a position where the first support leg is arranged on a side opposite to the image forming apparatus across the first sheet feeding apparatus in a horizontal direction, and, the first support leg does not come into contact with the first sheet feeding apparatus when the first sheet feeding apparatus slides to a separated position separated from the connected portion in the state in which the mounting portion is mounted to the mounted portion.

4. The image forming system according to claim 3,
wherein the image forming apparatus includes an opening/closing portion that is arranged, when viewed in the horizontal direction, at a position at least overlapping the connected portion configured to connect the first sheet feeding apparatus, and is configured to open a conveyance path configured to convey the sheet, and
wherein the opening/closing portion is configured to be opened in a state in which the first sheet feeding apparatus is positioned in the separated position.

5. The image forming system according to claim 1,
wherein the first support leg includes a first rotary member that is configured to roll on the floor surface.

6. The image forming system according to claim 1,
wherein the sheet supporting apparatus includes a second support leg including a contact portion configured to come into contact with the first sheet feeding apparatus in the state in which the mounting portion is mounted to the mounted portion,
wherein the second support leg is configured to support the sheet supporting portion via the contact portion.

7. The image forming system according to claim 6,
wherein the contact portion is a second rotary member configured to roll while coming into contact with the first sheet feeding apparatus, and
wherein, when the first sheet feeding apparatus moves in a horizontal direction, the second rotary member is configured to rotate and allow the first sheet feeding apparatus to relatively move with respect to the sheet supporting apparatus.

8. The image forming system according to claim 6,
wherein the sheet supporting apparatus includes a third support leg that is configured to move to a contact position in contact with the floor surface, and to a retracted position retracted from the floor surface, and
wherein, in a state in which the contact portion of the second support leg is not in contact with the first sheet feeding apparatus, the third support leg is configured to support the sheet supporting portion by being moved to the contact position.

9. The image forming system according to claim 8,
wherein the sheet supporting apparatus includes a holding mechanism configured to hold the third support leg at the retracted position or the contact position.

10. The image forming system according to claim 8,
wherein the third support leg includes a third rotary member configured to roll on the floor surface.

11. The image forming system according to claim 8,
wherein the sheet supporting portion is configured with a sufficient size to support a full length of a sheet which exceeds a maximum length that can be stored in the first sheet feeding apparatus.

12. The image forming system according to claim 1,
wherein the sheet supporting apparatus includes a fourth support leg that, in the state in which the mounting portion is mounted to the mounted portion, is arranged on a side closer to the image forming apparatus than the first support leg is in a horizontal direction, and
wherein the fourth support leg is configured to support the sheet supporting portion by coming into contact with the floor surface.

13. The image forming system according to claim 12,
wherein the image forming apparatus includes a connected portion configured to connect the first sheet feeding apparatus,
wherein the tray is configured to support the sheet, which is manually fed in an opened state, at a position above the connected portion, and
wherein the first support leg and the fourth support leg are arranged on a side opposite to the image forming apparatus with respect to the first sheet feeding apparatus in the horizontal direction.

14. The image forming system according to claim 12,
wherein the fourth support leg includes a fourth rotary member configured to roll on the floor surface.

15. The image forming system according to claim 1,
wherein the mounted portion includes one of a first pin extending in a mounting direction of the mounted portion and the mounting portion and a first hole that is configured to engage with the first pin, and one of a second pin extending in the mounting direction and a second hole that is configured to fit with the second pin with respect to a vertical direction and is longer than the second pin with respect to a horizontal direction, and
wherein the mounting portion includes another of the first pin and the first hole, and another of the second pin and the second hole.

16. The image forming system according to claim 1,
further comprising a lock mechanism configured to lock movement of the mounted portion and the mounting portion in a separation direction in the state in which the mounting portion is mounted to the mounted portion.

17. The image forming system according to claim 16,
wherein the lock mechanism includes a hook lever pivotably disposed at one of the mounted portion and the mounting portion, and a hook shaft disposed at another of the mounted portion and the mounting portion and configured to engage with the hook lever.

18. The image forming system according to claim 1,
wherein the sheet supporting portion includes an upper surface that is configured to support the sheet, and the upper surface is formed as a planar surface.

19. The image forming system according to claim 1,
wherein the first sheet feeding apparatus is configured to move in a horizontal direction, and
wherein the sheet supporting apparatus is configured to move independently from the first sheet feeding apparatus in the horizontal direction.
